(19) United States
(12) Patent Application Publication
(10) Pub. No.: US 2011/0260873 A1
(43) Pub. Date: Oct. 27, 2011

(54) Apparatus to Requests Assistance for a Service Animal Monitoring a Person

(75) Inventor: Norman Ken Ouchi, San Jose, CA (US)

(73) Assignee: M & K OUCHI FOUNDATION, San Jose, CA (US)

(21) Appl. No.: 12/767,432

(22) Filed: Apr. 26, 2010

(51) Int. Cl. G08B 23/00

(52) U.S. Cl. 340/573.3

(57) ABSTRACT

In the present invention, a service animal is trained to observe a person to detect conditions when assistance should be requested and trained to use a communications device with a service animal activated trigger to call for assistance with a recorded message.

### CROSS-REFERENCE TO RELATED APPLICATIONS

### None

### STATEMENT REGARDING FEDERALLY SPONSORED RESEARCH OR DEVELOPMENT

### None

### FIELD OF THE INVENTION

The present invention provides an apparatus and method for a trained service animal to monitor a person and to call for assistance when the animal determines assistance is needed.

### BRIEF SUMMARY OF THE INVENTION

In the present invention, a service animal is trained to observe a person to detect conditions when assistance should be requested and trained to use a communications device with a service animal activated trigger to call for assistance with a recorded message.

### BACKGROUND OF THE INVENTION

As the population ages, many individuals wish to continue independent living as long as possible. With modern medicine and good personal care, people are living well into their 90's and able to care for themselves. Many have lost their spouses and live alone. However, many live in fear of a fall or some accident or health problem that prevents them from requesting timely help. Life Alert and other companies provide a pendant or watch worn by the person who can used it to send a signal to a base station to call 911 or a monitoring service. A cell phone based device can also be used. The monitoring service calls to determine if assistance is needed. However, this apparatus fails when the person is unable to activate the switch on the pendant or watch. Low heart rate, stroke, heart attacks, and many accidents may render the person unable to activate the switch and request timely assistance that could save the person.

From time to time, news articles would appear describing how a dog trained to detect seizures called 911 and saved its master struck by a seizure. The dog was able to take the hand set off the phone cradle and push a speed dial button to call 911. The 911 operator was astute enough to hear the dog barking and send emergency aid. In another case, the 911 service had been informed that that a call from that phone number may be from a dog that is watching its master. These are unusual events with well trained dogs to use complex phones and 911 service prepared for a possible call.

People living alone are concerned that assistance cannot be summoned when needed. Some move to assisted living quarters where there is 24 hour surveillance of the living quarter exterior with meal and laundry services. The individuals are checked that they eat their meals or are called on a periodic basis. However, a person could be in distress and unable to call for assistance and not noticed until the next periodic check.

Many older people do not require 24 hour surveillance and in fact value their privacy and independence and do not want a person watching them all of the time either in person or by video or audio monitor. The bathroom and bedroom are areas where many people do not want observation. However, these people desire an unobtrusive observation that protects their privacy while providing continuous surveillance for emergencies where assistance is needed. Many would prefer to live at home, their familiar surroundings, and will make changes to continue their life at home.

### BRIEF DESCRIPTION OF DRAWINGS

FIG. 1 illustrates an apparatus for a service animal to call for assistance.

### DESCRIPTION OF THE INVENTION

### Trained Service Animal

Many people who live alone will have pets to keep them company. Dogs are trained to assist individuals with visual, hearing, and other impairments. Dogs are trained to warn their master when they detect signs of a possible seizure so the person can prepare for it. Many dogs are trained to be companion dogs, social companions, as pets. Small monkeys are trained to assist people with limited mobility by turning switches or bringing packages for cooking or caring for the person under the direction of the person. Even people concerned with their privacy will allow their pets to follow them everywhere in their homes: bedroom, bathroom, etc., rooms where many accidents occur. These are areas where human monitoring would not be permitted by most people.

People who have not had a pet would accept a service animal for independence. These service animals are not pets but, like dogs that assist the vision impaired, are trained for specific services. People will accept a person helping with the service animal if they can't care for the animals, e.g. take the animal for walks, clean-up after the animal, or even feed and water it. The assistance with animals can be scheduled and much less intrusive than 24/7 observation for safety.

Dogs are trained to detect when a person is behaving in a manner where assistance is required. This includes the person calling for help, the person in pain, the person not moving, lying on the floor, etc. Some other service animals like Capuchin monkeys may be trained to determine if the person requires assistance.

### An Apparatus for a Service Animal to Call for Assistance

However, this situation is not like little Timmy yelling from the bottom of the well, “Go for help, Lassie, go for help”. The service animal must call for help in an electronic environment. Most service animals cannot be trained to use a telephone to call for assistance. The hand set must be removed, the small speed dial buttons must be pushed, and the 911 operators are not expecting a call from an animal that can only bark or squeak.

The present invention provides a phone or communications device connected to the phone system or other network with a large button or another form of actuator or trigger that initiates a call to 911 or other predetermined phone number or receiver on the network. A recorded message is transmitted to identify the person, location, and the situation or other information when a service animal has detected a reason to call for assistance. A speaker phone function is provided so that the voice of the 911 operator may be heard and the person may be able to respond.

An alarm indicator, light and/or sound, is activated so that anyone nearby can tell that an emergency call for help has been initiated. The alarm indicator provides lower sound volume when the speaker phone is used. The alarm indicator also indicates to the person in distress that a call has been placed and relieve a level of anxiety.

An external alarm is activated to notify neighbors that assistance is requested. The external alarm may also notify surveillance personnel at an assisted living complex. The external alarm are speakers or lights outside the living area and visible to neighbors. The external alarm may be triggered by a wired or wireless signal from the apparatus 1.

The apparatus 1 provides a training mode where the apparatus 1 triggers the alarms and other external indicators of sending an assistance request while not calling the predetermined receiver. This will permit training of the service animal to respond to the condition of the person and activate the actuator to initiate the call. The person may perform periodic training exercises with the service animal to reinforce the behaviors.

A service that provide intrusion monitoring can also provide emergency assistance monitoring and filter out false alarms and make the call to 911 rather that directly from the apparatus 1.

The communications device may be a wireless phone where the device is carried in a pouch by the service animal. When emergency assistance is required, the service animal pulls the device from the pouch and activates the call. This will permit the person to travel alone with the service animal. Many wireless phones provide GPS location information that can be transmitted with the recorded message.

There may be two or more devices for the service animal to summon assistance where each has a message describing the location of the device or other information to distinguish the call to aid the emergency personnel as they take the call. A large house may have many rooms and each room may have a device with a message describing the room where the service animal made the call. This may assist the emergency personnel to locate the person in shorter time.

The apparatus may be mounted to avoid accidental triggering by the animal, the person, or guests.

The actuator to activate the apparatus is illustrated as a button. However, one of ordinary skill can envision other actuators such as a light beam that is broken by the paws or body of a service animal, an audio receiver calibrated to decode a bark or barking pattern, a lever for a monkey to pull, a pair of buttons where a dog places both front paws to trigger the apparatus, a bone shaped handle to pull a rope, or any number of devices suitable to train a service animal to activate the apparatus.

The apparatus may also be used by a person with a vocal impairment and unable to tell the emergency service operator the need and location for assistance.

The apparatus may have multiple phone or receiver addresses to attempt connection and dial each in sequence until one receiver accepts the message.

Many monitored people have children or others who are concerned for their health and safety. The apparatus may have a second phone or receiver address to call in addition to the primary request for assistance to notify them when a request has been transmitted to the primary receiver.

### DESCRIPTION OF A PREFERRED EMBODIMENT

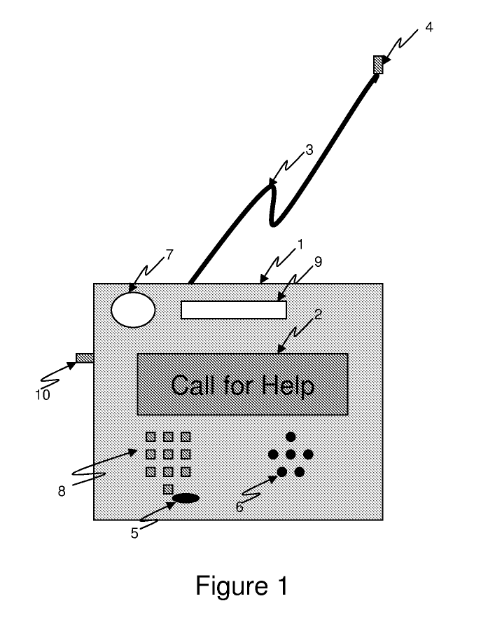

An embodiment of the present invention is illustrated in FIG. 1. The apparatus 1 comprises a call button 2 which activates the call for assistance and other administrative functions; a signal cord 3 to connect the apparatus 1 to a network using a connector 4; a microphone 5 for a speaker phone function and recording the prerecorded message; a speaker 6 for the speaker phone function and an audible alarm when the apparatus 1 is activated; a light 7 for a visible alarm when the apparatus 1 is activated; a numeric key pad 8 to enter the phone number that is stored as the preset phone number; a numeric display 9 that displays the phone number entered on the numeric key pad 8; and a mode switch 10 to set the apparatus 1 into either:

1) an active mode where depressing the call button 2 will activate a call for assistance to a preset phone number as a speaker phone, play the recorded voice message, and activate the alarms;
2) a training mode where depressing the call button 2 will activate the alarms and play the recorded message;
3) a recording mode where depressing the call button 2 will record a voice message spoken into the microphone 5 as the recorded message;
4) a phone number preset mode where depressing the call button 2 will record the number entered in the numeric key pad 8 and display in the display 9 as the preset phone number. The apparatus 1 is comprised of electronics for a speaker phone that are modified with additional electronics where the mode switch 10 sets the electronics into one of four modes:
1) in the active mode, depressing the call button 2 activates the speaker phone function, calls the phone number stored in a predetermined speed dial address; a voice encoding/synthesizer chip with a memory chip as used in recordable audio greeting cards or other electronic device to transform an encoded voice message stored in the memory chip to a voiced message; activates the alarm light 7 and audible alarm in the speaker 6;
2) in the training mode, depressing the call button 2 activates the voice synthesizer chip to decode the stored message as a voice message in the speaker 6; activates the alarm light 7 and audible alarm in the speaker 6;
3) in the recording mode, depressing the call button 2 erases the contents of the memory chip and while the call button 2 continues to be depressed, the audio message spoken into microphone 5 is encoded by the encoding/synthesizer chip and stored in the memory chip as the voice message;
4) in the phone number preset mode to determine the message receiver, depressing the call button 2 erases the contents of the predetermined speed dial address and while the call button 2 continues to be depressed, the number entered in the numeric key pad 8 is stored in the predetermined speed dial address and displayed in the display 9.

Examples of single chip full duplex speaker phone functions are Cirrus Logic CS6422 or Conexant CX20662 or Sames SAN2202B or Austrimicrosystems AS2522B and examples of digital voice encoding-synthesizer chip are Eletech VP1000 or A-Plus aIVR1004. With these two chips, one of ordinary skill can fabricate a unit providing the described functions. Other components such as apparatus case, buttons, speakers, etc. are readily available from retail and wholesale providers.

The network may be the wired telephone network, cell phone network, internet, or other communication network providing an addressable connection and message transmitting capability.

The message may be a voice message, a text message, a web page, a video file, a fax, or other recordable message.

External alarm may be connected to the alarm light 7 or speaker 6 to drive external lights or speakers. The connection may be directly wired, a wireless connection, or other signal to trigger an external alarm.

The call button 2 may be pressure activated pad, a light sensor beam triggered when broken, an audio detector triggered by a series of barks or other animal sounds, a pair of buttons that fit the two front paws to minimize accidental triggering, a lever suitable for a small monkey to pull, or other transducer suitable for a service animal to be trained to actuate.

I claim:

1. An apparatus suitable for a service animal monitoring a person to call for assistance by transmitting an identifying message to a receiver comprising:
a communications device connected to a network with an actuator suitable for a service animal to activate the communications device where
upon activation, the communications device transmits an identifying message requesting assistance to a predetermined first receiver on the network.

2. The apparatus of claim 1 emits an alarm when the apparatus is activated.

3. The apparatus of claim 1 emits a signal to activate an external alarm when the apparatus is activated.

4. The apparatus of claim 1 provides means to record the identifying message.

5. The apparatus of claim 1 provides means to determine the first receiver on the network to receive the request for assistance.

6. The apparatus of claim 1 wherein the identify message provides information on the person needing assistance.

7. The apparatus of claim 1 providing two way communications.

8. The apparatus of claim 1 providing a training mode wherein the communications device does not send the message when the actuator is activated.

9. The apparatus of claim 1 providing a predetermined second receiver and transmits the message to the second receiver.

10. A method for a service animal to monitor a person and call for assistance when required comprising the steps:
providing a person;
providing a first communications device connected to a network with an actuator suitable for a service animal to activate the first communications device where upon activation, the communications device transmits a first recorded message requesting assistance to a predetermined receiver on the network;
providing a service animal trained to monitor the person and to detect conditions requiring assistance and activate the communications device using the actuator to call for assistance.

11. The method of claim 10 providing a second communications device connected to the network with an actuator suitable for service animal activation where upon activation, the second communications device transmits a second message to the predetermined receiver on the network requesting assistance.

12. The method of claim 10 wherein the first communication device provides a training mode to teach the service animal to activate the first communications device without transmitting a message.

13. The method of claim 10 wherein the first communications device emits an alarm when activated.

14. The method of claim 10 wherein the first communications device provides means to record the first message.

15. A method for a service animal to monitor a person and call for assistance when required comprising the steps:
providing a person to be monitored;
providing a first communications device, connected to a network, with an actuator suitable for service animal activation and upon activation, the first communications device sends a first recorded message to a predetermined receiver on the network;
training a service animal to monitor the person to detect when assistance is required and activate the first communications device in a training mode without transmitting a message;
providing the trained service animal to monitor the person to detect when assistance is required and activate the first communications device to send the message requesting assistance.

16. The method of claim 15 wherein the service animal training is repeated to reinforce the monitoring and communications device activation behaviors.

17. The method of claim 15 wherein the first communications device emits an alarm when activated.

18. The method of claim 15 wherein the first communications device provides means to record the first message.

19. The method of claim 15 wherein the first communications device provides means to determine the first receiver on the network.

20. The method of claim 15 providing a second communications device connected to the network with an actuator suitable for service animal activation where upon activation, the second communications device transmits a second message to the predetermined receiver on the network requesting assistance.
